(19) United States
(12) Patent Application Publication
(10) Pub. No.: US 2020/0202231 A1
(43) Pub. Date: Jun. 25, 2020

(54) SELF-GENERATING RULES FOR INTERNET OF THINGS

(71) Applicant: SAP SE, Walldorf (DE)

(72) Inventors: Shailesh Jannu, Fremont, CA (US); Bin Duan, Mountain View, CA (US); Ashish Bhan, Palo Alto, CA (US); Michelle Gary, San Jose, CA (US)

(21) Appl. No.: 16/225,604

(22) Filed: Dec. 19, 2018

(51) Int. Cl. G06N 5/02; G06N 5/00; G06N 20/00; H04L 29/08

(52) U.S. Cl. CPC G06N 5/025; H04L 67/12; G06N 20/00; G06N 5/003

(57) ABSTRACT

A method includes receiving sensor data from a sensor, evaluating the sensor data against rules stored in a rules repository, each rule associating one or more conditions with an action, including determining an action for which each one or more associated condition is satisfied, determining, based on rules stored in the rules repository and the sensor data, an additional condition to associate with the action, presenting a new rule to a user for validation based on the additional condition, and upon user validation, adding the new rule to the rules repository.

### BACKGROUND

A wide range of customer-facing and revenue-generating devices are often unmonitored, sitting quietly in retail stores, gas stations, or street corners. This presents challenges for conducting periodic device audits and capturing insights on device health, location, and performance. For example, one may not know if the device temperature or humidity are properly maintained on a consistent basis, whether the devices are consistently producing the optimal sales performance, or whether they currently have adequate inventory stock levels. Even more, one may not know whether a device is still placed at its designated location or has been lost or stolen.

In many Internet of Things (IoT) settings, the devices are instrumented with sensors which measure properties related to the operation thereof. Monitoring these measured properties may provide insight into the operational status of the devices and whether a follow-on action should be performed.

Traditionally, a user manually defines rules based on limited knowledge of a range of possible conditions that could occur, which is prone to error. Further, conditions may change dynamically based on real-time behavior. A user manually updates the rules as new conditions occur, which is inefficient. It may be beneficial to evaluate the conditions occurring in real-time and identify or suggest new rules for the user.

Systems are desired to efficiently determine new rules based on data generated by sensors associated with devices.

### BRIEF DESCRIPTION OF THE DRAWINGS

FIG. 1 is a block diagram of an architecture according to some embodiments.

FIG. 2 is a more detailed block diagram of a system architecture according to some embodiments.

FIG. 3 is a flowchart illustrating an exemplary process according to some embodiments.

FIG. 4 is an outward view of user interface according to some embodiments.

FIG. 5A is a diagram of a decision tree according to some embodiments.

FIG. 5B is a table showing a set of rules according to some embodiments.

FIG. 6 shows an example of a table or a view used as input to a decision tree according to some embodiments.

FIG. 7A is a diagram of a decision tree according to some embodiments.

FIG. 7B is a table showing a set of rules according to some embodiments.

FIG. 8 is a block diagram of an apparatus according to some embodiments.

### DETAILED DESCRIPTION

Features and advantages of the example embodiments, and the manner in which the same are accomplished, will become more readily apparent with reference to the following detailed description taken in conjunction with the accompanying drawings.

The following description sets forth specific details to provide a thorough understanding of the various example embodiments. It should be appreciated that various modifications to the embodiments will be readily-apparent to those skilled in the art, and the generic principles defined herein may be applied to other embodiments and applications without departing from the spirit and scope of the disclosure.

Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the described embodiments, but is to be accorded the widest scope consistent with the principles and features disclosed herein.

Some embodiments provide a technical solution to the above-described technical problem by automatically predicting or identifying underlying features for new rules and recommending the new rules to a user based on data generated by sensors associated with devices. The new rules may be based on historical rules and data patterns in the data (e.g., relevant device trends and usage patterns). The new rules may include conditions that the user is not aware of Data classification and regression according to some embodiments may employ semi-supervised learning techniques.

The provided solution may help maximize the value of mass-market and smart devices, such as coolers, vending machines, and power tools, through automated monitoring and management. Device availability, utilization, and performance are optimized, for example, by helping ensure adequate stock levels, proper storage conditions, monitoring performance, utilization, and proper functioning.

The environments described herein are merely exemplary, and it is contemplated that the techniques described may be extended to other implementation contexts.

One or more embodiments that include one or more of the advantages discussed are described in detail below with reference to the figures.

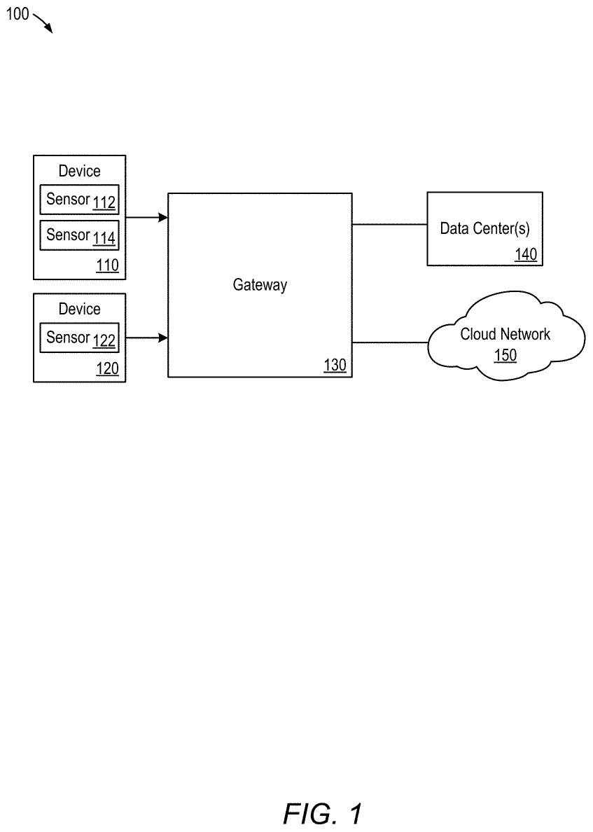

FIG. 1 is a block diagram of an architecture 100 according to some embodiments. Architecture 100 includes devices 110 and 120 which may comprise any hardware devices that are or become known. In one non-exhaustive example, devices 110 and 120 are a subset of devices an Internet of Things (IoT) environment. Examples of such devices include, but are not limited to, containers, silos, coolers, vending machines, or other receptacles in which products are stored and distributed across public or private locations. Examples of such devices may also include other product categories such as wellness equipment or construction tools. Devices 110 and 120 need not be in proximity to one another.

Each of devices 110 and 120 is associated with one or more sensors. Association of a sensor with a device indicates that the data generated by the sensor is related to the device. The data may reflect temperature of the device, temperature of ambient air surrounding the device, temperature of a specific component of the device, rotations per minute, pressure, location of the device, door open time, etc.

In some embodiments, gateway 130 consolidates and routes data from sensor devices 110 and 120 to data systems within data center 140 or cloud network 150.

Specifically, device 110 is associated with sensors 112 and 114 and device 120 is associated with sensor 122 as is known in the art. These sensors (and devices) are in communication with gateway 130, which may provide some “edge” processing of sensor data as is known in the art. Gateway 130 is also in communication with network 150 in order to provide sensor data generated by sensors 112, 114, and 122 to network cloud network 150, which may comprise any one or more public and/or private networks. Depiction of a sensor within a device as shown in FIG. 1 is only intended to illustrate an association between the sensor and the device, and is not intended to limit the association to any particular physical relationship.

In some embodiments, a data center 140 receives the sensor data generated by the sensors of architecture 100. The data center 140 (e.g., a data storage platform such as a database or a data warehouse) may comprise a distributed processing and/or storage architecture.

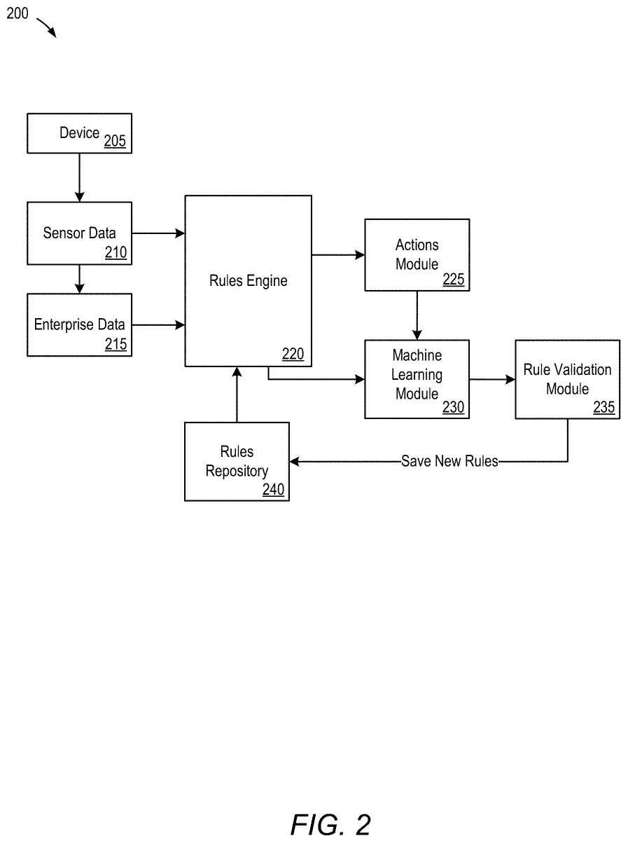

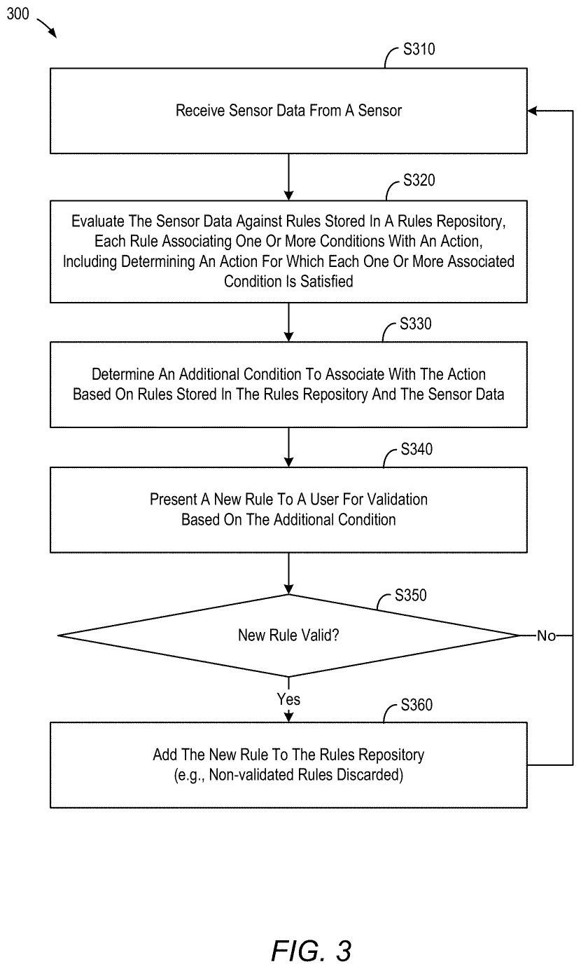

Reference is now made to FIGS. 2 and 3, which will be discussed together.

FIG. 2 is a more detailed block diagram of a system architecture 200 according to some embodiments. More specifically, FIG. 2 is a block diagram of architecture 200 to perform process 300, described below, according to some embodiments. Architecture 200 includes device 205, sensor data 210, enterprise data 215, rules engine 220, actions module 225, machine learning module 230, rule validation module 235, and rules repository 240.

FIG. 3 is a flowchart of a process 300 according to some embodiments. Process 300 and the other processes described herein may be performed using any suitable combination of hardware and software. Software embodying these processes may be stored by any non-transitory tangible medium, including but not limited to a fixed disk, non-volatile random access memory, volatile random access memory, a DVD, a Flash drive, or a magnetic tape.

Initially, at S310, rules engine 220 receives sensor data 210 from a sensor. Each of the sensors from which data is received is associated with a device (e.g., device 205). For example, sensor data may be received at S310 from sensors 112, 114, and 122 of architecture 100, each of which is associated with a device 110, 120 as depicted in FIG. 1 or a device 205 as depicted in FIG. 2. According to some embodiments, the data is stored on one or more storage nodes (e.g., gateway 130), and later retrieved at S310 for processing.

Next, at S320, rules engine 220 evaluates the sensor data is against rules stored in a rules repository 240. Each rule associates one or more conditions with an action (e.g., rule-based alerts taken by action module 225). This evaluation includes determining an action for which each one or more associated condition is satisfied (e.g., fulfills the requirements of the rule).

At S330, machine learning module 230 may be implemented by a computer processor to identify an additional (e.g., new) condition for a rule. Machine learning module 230 determines an additional condition to associate with the action based on rules stored in the rules repository 240 and the sensor data 210. In some embodiments, the sensor data 210 is merged with enterprise data 215 to gain insights.

Machine learning module 230 uses a decision-tree approach to determine the additional condition to associate with the action. In some embodiments, the additional condition is determined using a Classification and Regression Tree (CART) based model or similar analytic approach (e.g., Random Forest (RF) model). In some embodiments, the action includes actions module 225 generating an alert notification. In some embodiments, the machine learning method is implemented periodically at fixed time intervals (e.g., in batch mode). In other embodiments, the machine learning method is implemented intermittently, when new data is detected. In yet other embodiments, the machine learning method is implemented on a scheduled basis, such as when the volume of the new data received reaches or exceeds a specified data volume, or on demand.

Based on the additional condition determined at S330, machine learning module 230 presents a new rule to a user for validation at S340 (e.g., via rule validation module 235). The new rule may include an additional condition for the new rule or an additional condition to an existing rule stored in the rules repository.

A user may approve the alert, take an action on the alert, or dismiss the alert. At S350, if the user determines that the rule is valid (e.g., acceptable), the new rule is added to the rules repository 240, at S360. Non-validated (e.g., unacceptable, user-dismissed) rules are discarded. The new rule is then used on data subsequently collected.

Flow may then return from S360 to S310 to receive more sensor data. Iterative execution of process 300 in this manner may facilitate refinement of the algorithms used at S320 and S330 via semi-supervised learning.

Each of the components illustrated and described herein may be implemented by software and/or one or more hardware elements, with some software and/or hardware elements being shared among more than one illustrated component. One or more of the software and/or hardware elements may be located in a cloud deployment or on-premise. Embodiments are not limited to architectures as shown in FIGS. 1 and 2.

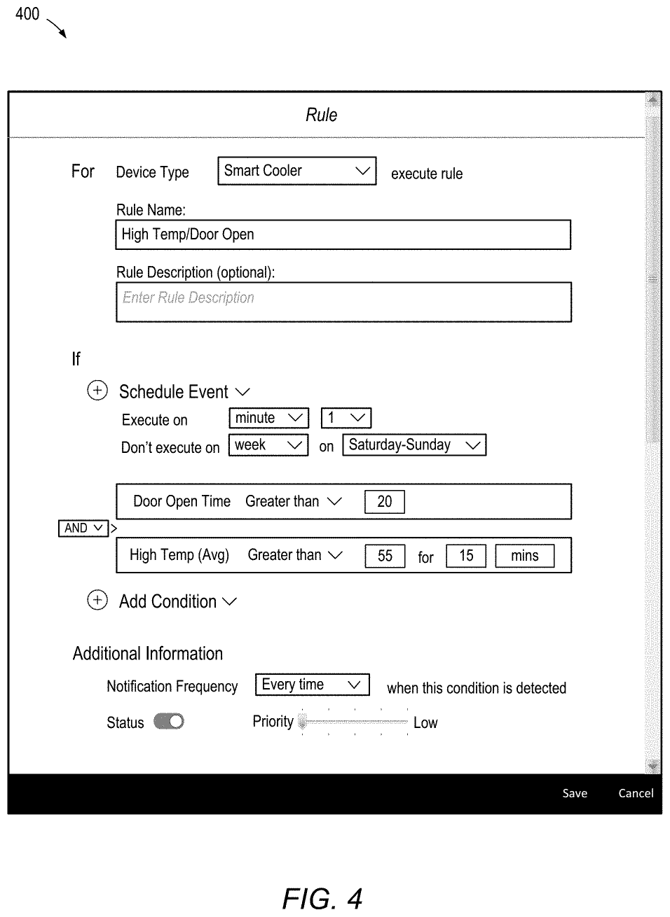

FIG. 4 is an outward view of user interface (UI) according to some embodiments. More specifically, FIG. 4 illustrates a UI window 400 on a display screen that allows configuration of rules, which may be stored in rules repository 240 and used by rules engine 220 for evaluating sensor data. Rules engine 220 enables users to set up rules that will trigger certain actions under conditions specified.

The example UI 400 creates a rule for a cooler that will check once a minute every day (excluding weekends) to determine whether the cooler's average temperature has been greater than 55 degrees Fahrenheit for 15 minutes and its door has been open for more than 20 minutes. If this condition is detected, it will send a notification email to the contact person for the cooler.

When a specified event occurs and the rule's conditions are met, the rule will trigger an action such as a notification. As shown in FIG. 4, rules may include, but are not limited to, a device type, a rule name, a description for the rule, an event, rule conditions, and an action.

To create a rule, the logic used to determine that a certain event has occurred is first defined. In addition, a user can set one or more actions to be performed every time the event occurs.

By way of example, referring to FIG. 4, under “If”, a user may use the “Schedule Event” control to set up an event to check for the rule conditions at a specified time interval. A user may also choose when not to check for the rule conditions (e.g., on evenings or weekends). A user may use the “Add Condition” control to choose values to represent the conditions that will trigger a notification. To follow the example above, consider that a user might create an event with criteria that specify the temperature of a device rising above 55 degrees Fahrenheit. A rule might then trigger a notification for this event if certain additional conditions are met, for example, the device contains ice cream and the device door has been closed for 30 minutes.

In one example, a user may optionally choose one or more measures for the rule (e.g., temperature, pressure, power state, battery level, etc.), and specify any thresholds. In another example, a user may optionally choose one or more dimensions for the rule and specify its details (e.g., to apply the rule only to device IDs with a prefix “AA”). In yet another example, a more complex condition may be created using an aggregator (e.g., a mathematical calculation such as average or sum that is performed on a measure). A user may add as many measures, dimensions, and aggregations as desired, modifying the operators (e.g., AND, OR) between them as needed to define the rule.

In some embodiments, a user may set a notification frequency with which the action should occur (e.g., every time the condition is detected, or just the first time it is detected). In some embodiments, a rule “Status” button may be used to activate or deactivate a rule and a “Priority” slider may be used to choose a priority for the rule. Additionally or alternatively, a rule may specify other parameters or other combinations of parameters.

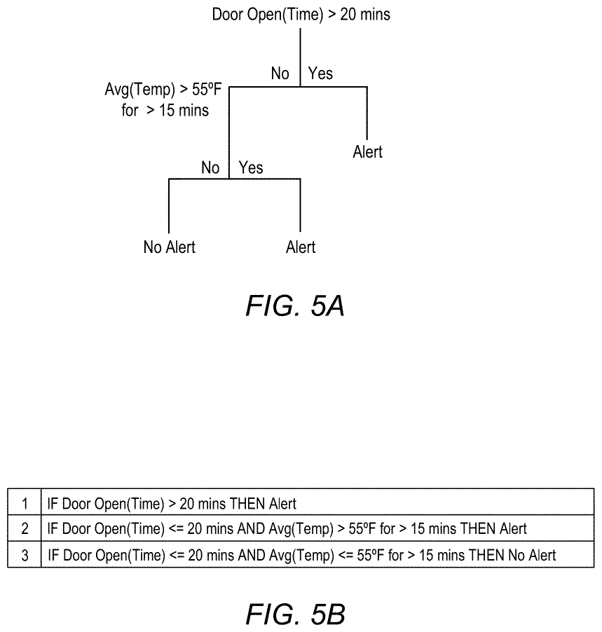

FIG. 5A is a diagram of a decision tree applied to a set of conditions, according to an example embodiment. More specifically, FIG. 5A shows an example representation of a Classification and Regression Tree (CART) (e.g., decision tree) constructed by machine learning module 230 using machine learning techniques.

As shown in FIG. 5A, the decision tree is a flowchart-like structure that includes a topmost root node, internal leaf nodes, and final/terminal nodes. Each root and internal node of the tree represents a test (e.g., Door Open (Time)>20 mins) associated with an input variable/attribute (e.g., time). At a decision point, the inputs to the decision tree are operating conditions of a sensor (e.g., door open time, temperature, pressure, etc.) which are measured and fed into the decision tree.

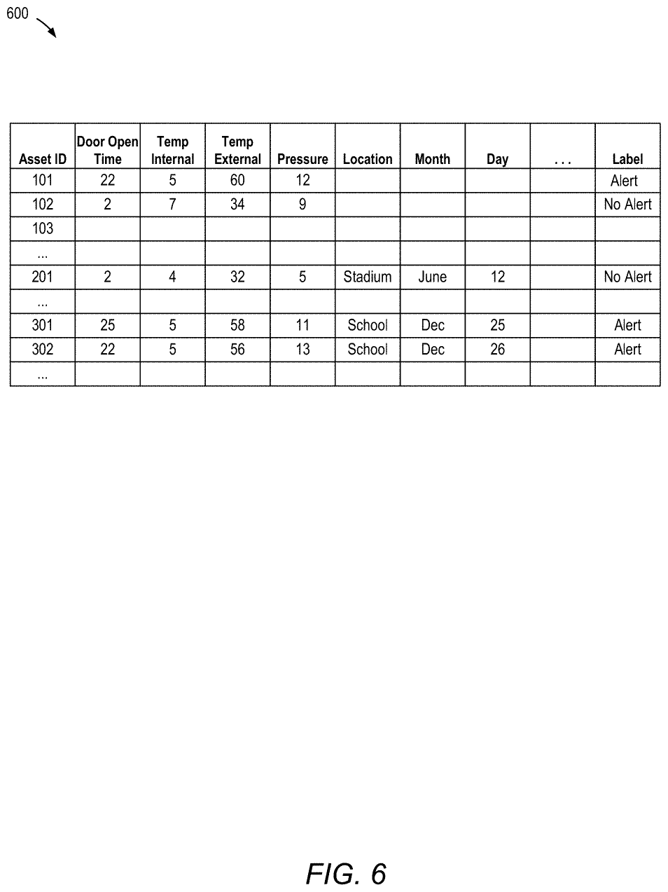

FIG. 6 shows an example of a table or a view used as input to a decision tree according to some embodiments. Table 600 includes fields for one or more assets or devices that are used by the CART model to derive the rules.

In some embodiments, table 600 may be configured to store data related to sensor elements. For example, table 600 may store a sensor identification number and sensor element specific data for all or a subset of sensor elements.

The last column of table 600 includes a classification label (e.g., Alert/No Alert). This classification is more accurately defined as the system collects more data values from the sensors. Many of the columns in the table may be empty to begin with, but may be gradually populated over time. The table may be formed by joining tables or views. As the data evolves and different pieces of information are added to the system (e.g., new data entered, existing data modified), the rules may change to incorporate this new information. When this data becomes available to the machine learning module 230, the decision tree will use this new information to define new rules (e.g., outputs a decision on whether an Alert or No Alert should be raised). The new rules are then applied to new data that is received, which may in turn generate new actions or alerts.

Corresponding tests are performed in the nodes, starting with the root node and ending when the process reaches one of the terminal nodes. Each terminal node holds a class label (e.g., Alert or No Alert) that may be used to make a prediction. By performing top-down greedy search through the decision tree, machine learning module 230 makes a prediction for the best (e.g., most accurate) action to be asserted and applied using the most parsimonious combination of variables (e.g., fewest number of variables). The decision tree can handle both numerical as well as categorical data.

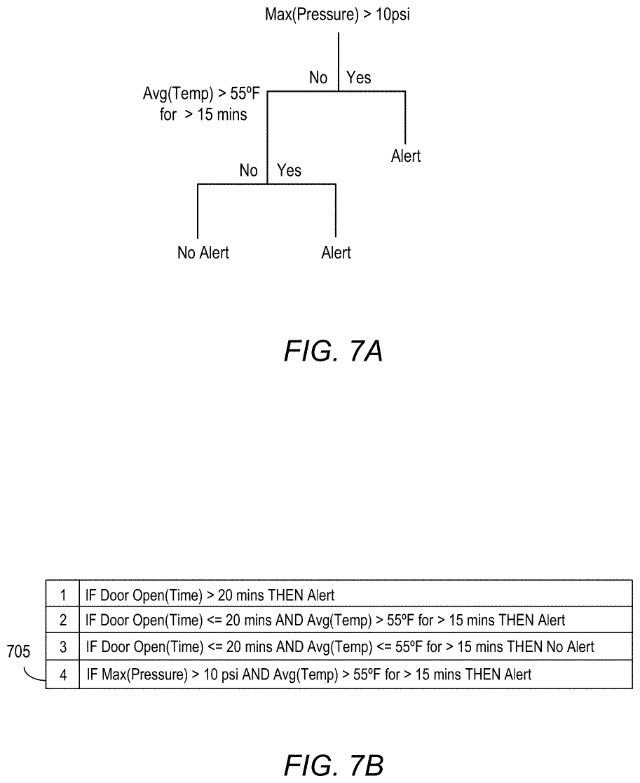

As described above, growing a tree involves determining which variables to use and conditions for splitting. In this regard, FIG. 7A shows another binary tree representation of the CART model described above, similar to that of FIG. 5A, but with a different combination of variables (e.g., pressure and temperature) that machine learning module 230 has determined to most accurately classify the data.

For example, referring back to FIG. 3, in step S330, it may be determined to associate the additional condition “Max(Pressure)>10 psi” with the action from step S320 based on rules stored in the rules repository (e.g., as shown in FIG. 5B) and the sensor data (e.g., as shown in FIG. 6). In turn, a new rule “IF Max(Pressure)>10 psi AND Avg(Temp)>55° F. for >15 mins THEN Alert” 705 may be presented to a user for validation. As shown in FIG. 7B, the new rule 705 may be added to the rules repository, as per step S360.

The decision tree can be stored to a file as a graph, as shown in FIGS. 5A and 7A, or to a table as a set of rules, as shown in FIGS. 5B and 7B.

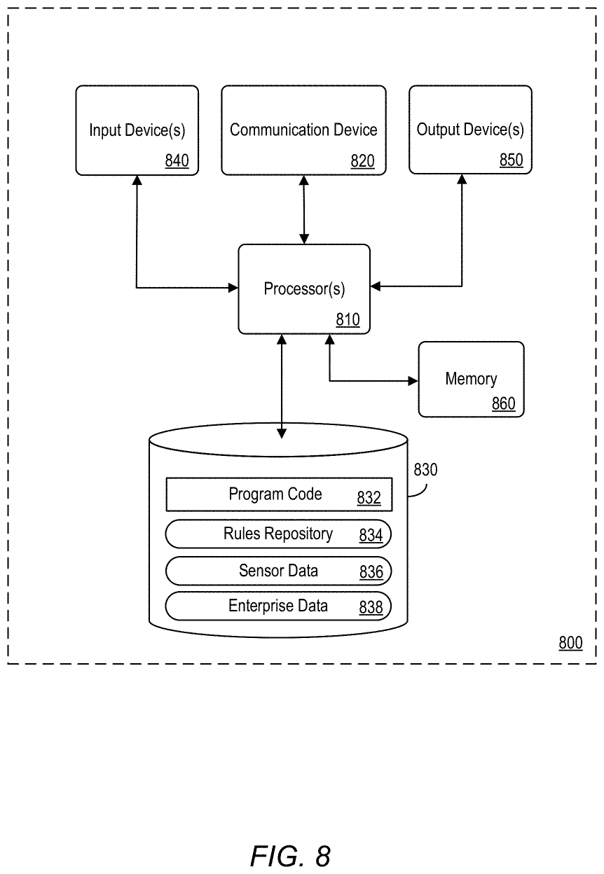

FIG. 8 is a block diagram of apparatus 800 according to some embodiments.

Apparatus 800 may comprise a general- or special-purpose computing apparatus and may execute program code to perform any of the functions described herein. Apparatus 800 may comprise an implementation of one or more elements of system 200. Apparatus 800 may include other unshown elements according to some embodiments.

Apparatus 800 includes processor(s) 810 operatively coupled to communication device 820, data storage device 830, one or more input devices 840, one or more output devices 850, and memory 860. Communication device 820 may facilitate communication with external devices. Input device(s) 840 may comprise, for example, a keyboard, a keypad, a mouse or other pointing device, a microphone, knob or a switch, an infra-red (IR) port, a docking station, and/or a touch screen. Input device(s) 840 may be used, for example, to manipulate graphical user interfaces and to input information into apparatus 800. Output device(s) 850 may comprise, for example, a display (e.g., a display screen), a speaker, and/or a printer.

Data storage device 830 may comprise any appropriate persistent storage device, including combinations of magnetic storage devices (e.g., magnetic tape, hard disk drives and flash memory), optical storage devices, Read Only Memory (ROM) devices, etc., while memory 860 may comprise Random Access Memory (RAM).

Program code 832 of data storage device 830 may be executable by processor 810 to provide functions described herein, including but not limited to process 300. Embodiments are not limited to execution of these functions by a single apparatus. Data storage device 830 may store a rules repository 834, sensor data 836, and enterprise data 838. Data storage device 830 may also store data and other program code for providing additional functionality which are necessary for operation thereof, such as device drivers, operating system files, etc.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non-transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, semiconductor memory such as read-only memory (ROM), and/or any transmitting/receiving medium such as the Internet, cloud storage, the internet of things, or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

The foregoing diagrams represent logical architectures for describing processes according to some embodiments, and actual implementations may include more or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation of a system according to some embodiments may include a processor to execute program code such that the computing device operates as described herein.

All systems and processes discussed herein may be embodied in program code stored on one or more non-transitory computer-readable media. Such media may include, for example, a floppy disk, a CD-ROM, a DVD-ROM, a Flash drive, magnetic tape, and solid state Random Access Memory (RAM) or Read Only Memory (ROM) storage units.

Embodiments are therefore not limited to any specific combination of hardware and software.

Embodiments described herein are solely for the purpose of illustration. Those in the art will recognize other embodiments may be practiced with modifications and alterations to that described above.

What is claimed is:

1. A computer-implemented method comprising:
receiving sensor data from a sensor;
evaluating the sensor data against rules stored in a rules repository, each rule associating one or more conditions with an action, including determining an action for which each one or more associated condition is satisfied;
determining, based on rules stored in the rules repository and the sensor data, an additional condition to associate with the action;
presenting a new rule to a user for validation based on the additional condition; and
upon user validation, adding the new rule to the rules repository.

2. The method of claim 1, the determining further comprises determining the additional condition using a decision tree algorithm.

3. The method of claim 1, wherein the determining further comprises determining the additional condition using a Classification and Regression Tree (CART) based model.

4. The method of claim 1, wherein the sensor data is received from a sensor associated with an Internet of Things (IoT) device.

5. The method of claim 1, wherein the new rule includes an additional condition for the new rule or an additional condition to an existing rule stored in the rules repository.

6. The method of claim 1, wherein the action includes generating an alert notification.

7. The method of claim 1, further comprising discarding new rules that are not validated by the user.

8. A system comprising:
one or more sensors;
a data store configured to store rules, the rules specifying the performance of actions based on sensor data from the one or more sensors;
a rules engine associated with the data store configured to:
receive sensor data from the one or more sensors; and
evaluate the sensor data against rules stored in the data store, each rule associating one or more conditions with an action, including determining an action for which each one or more associated condition is satisfied;
a machine learning module determining, based on rules stored in the data store and the sensor data, an additional condition to associate with the action; and
a display configured to present a new rule to a user for validation based on the additional condition, wherein the new rule is added to the data store upon user validation.

9. The system of claim 8, the determining further comprises the machine learning module determining the additional condition using a decision tree algorithm.

10. The system of claim 8, wherein the sensor data is received from a sensor associated with an Internet of Things (IoT) device.

11. The system of claim 8, wherein the new rule includes an additional condition for the new rule or an additional condition to an existing rule stored in the rules data store.

12. The system of claim 8, wherein rules stored in the data store include user-defined rules.

13. The system of claim 8, wherein the action includes generating an alert notification.

14. The system of claim 8, further comprising discarding new rules that are not validated by the user.

15. A non-transitory computer-readable medium having stored therein instructions that when executed cause a computer to perform a method comprising:
receiving sensor data from a sensor;
evaluating the sensor data against rules stored in a rules repository, each rule associating one or more conditions with an action, including determining an action for which each one or more associated condition is satisfied;
determining, based on rules stored in the rules repository and the sensor data, an additional condition to associate with the action;
presenting a new rule to a user for validation based on the additional condition; and
upon user validation, adding the new rule to the rules repository.

16. The non-transitory computer-readable medium of claim 15, wherein the determining further comprises determining the additional condition using a Classification and Regression Tree (CART) based model.

17. The non-transitory computer-readable medium of claim 15, wherein the sensor data is received from a sensor associated with an Internet of Things (IoT) device.

18. The non-transitory computer-readable medium of claim 15, wherein the new rule includes an additional condition for the new rule or an additional condition to an existing rule stored in the rules repository.

19. The non-transitory computer-readable medium of claim 15, wherein the action includes generating an alert notification.

20. The non-transitory computer-readable medium of claim 15, further comprising discarding new rules that are not validated by the user.
